(19) United States
(12) Patent Application Publication
(10) Pub. No.: US 2007/0236799 A1
(43) Pub. Date: Oct. 11, 2007

(54) Mirror for solid-state laser

(75) Inventor: Ryo Tateno, Kyoto (JP)

Correspondence Address: SUGHRUE MION, PLLC, 2100 PENNSYLVANIA AVENUE, N.W., SUITE 800, WASHINGTON, DC, 20037, US

(73) Assignee: SHIMADZU CORPORATION, Kyoto-shi (JP)

(21) Appl. No.: 11/650,547

(22) Filed: Jan. 8, 2007

(30) Foreign Application Priority Data
Jan. 19, 2006 (JP) 2006-010566

(51) Int. Cl. G02B 1/10

(52) U.S. Cl. 359/588

(57) ABSTRACT

A mirror for a solid-state laser, has a multilayer film formed by alternately laminating a low-refractive-index film layer and a high-refractive-index film layer on a substrate. In the mirror, each of the film layers has an optical film-thickness set at a fundamental value in conformity to a wavelength of target light, except that at least one of the film layers has an optical film-thickness adjusted to allow a peak of an electric field intensity distribution formed by repetitive reflections at boundary surfaces between the adjacent film layers to be located in the low-refractive-index film layer.

### BACKGROUND OF THE INVENTION

1. Field of the Invention

The present invention relates to a multilayer-film mirror for use in a solid-state laser, such as LD (laser diode)-pumped YAG (yttrium aluminum garnet) oscillator-based all-solid-state laser, and more particularly to a multilayer-film mirror suitable for use in the deep-ultraviolet range.

2. Description of the Related Art

A LD-pumped solid-state laser apparatus is designed to generate oscillation using an oscillator defined, for example, between a reflection surface formed at one end of a solid-state laser medium and an output mirror. Heretofore, such an output mirror has been made up of a mirror with a multilayer film structure formed by alternately laminating a high-refractive-index dielectric layer (typically, refractive index: 1.9 or more) and a low-refractive-index dielectric layer (typically, refractive index: 1.5 or less) (see, for example, Japanese Patent Laid-Open Publication No. 05-55671). As a typical design approach of this multilayer-film mirror, a target reflection wavelength range and a target reflectance are determined, and then the number of film layers, an optical film-thickness of each film layer and optical characteristics of each film layer, such as refractive index, are appropriately determined in consideration of absorption, scattering, stress, etc., in the film layers.

In view of achieving enhanced oscillation efficiency of laser in a LD-pumped solid-state laser apparatus, it is desirable that the mirror has higher reflectance, i.e., a reflectance closer to 100%. As a way of increasing the reflectance, it is necessary to suppress light absorption by the film layer and reduce a surface roughness of the film layer. If light is subjected to absorption by the film layer, the light energy will be attenuated. In a laser mirror where light is repeatedly reflected thereby, even if the attenuation is negligibly small in each reflection, it will be increased along with the repetition of reflection to cause deterioration in oscillation efficiency. Thus, it is necessary to use a film layer made of a material having possibly lower light adsorbability in a wavelength range of light to be used.

Even though the above technique of suppressing light absorption by the film layer and reducing a surface roughness of the film layer the reflectance can be used to increase the reflectance, a reflectance of 99% or more is hardly achieved by simply using such a technique. Moreover, while no serious problem occurs in a low-power laser, a high-power laser is likely to cause damages (particularly, thermal destruction) of the film layers in the multilayer mirror along with increase in used hours, to accelerate deterioration of the reflectance, resulting in unusable state.

### SUMMARY OF THE INVENTION

In view of the above problems, it is an object of the present invention to provide a mirror for a solid-state laser, capable of achieving higher reflectance than ever before and enhanced durability, particularly when used in a high-power laser apparatus.

In order to achieve the above object, the present invention provides a mirror for a solid-state laser, which comprises a multilayer film formed by alternately laminating, on a substrate, a high-refractive-index film layer made of a dielectric material having a relatively high refractive index and a low-refractive-index film layer made of a dielectric material having a relatively low refractive index. In the mirror, at least one of the film layers has an optical film-thickness adjusted such that a peak of an electric field intensity in the multilayer film with respect to a wavelength of intended light appears in the low-refractive-index film layer.

As used in this specification, the term “relatively high refractive index” means a refractive index of about 1.9 or more, and the term “relatively low refractive index” means a refractive index of about 1.5 or less.

In the mirror of the present invention, a total number of the film layers in the multilayer film may be generally set at 20 or more, typically in the range of about 25 to 30. Further, each of the film layers may be designed to have a fundamental optical film-thickness which is an integral multiple of ½ of the wavelength λ of the intended light. An electric field intensity distribution in the multilayer film is formed by a superimposition of repetitive reflections at boundary surfaces between the adjacent film layers. Thus, when an optical film-thickness is changed, an electric field intensity peak is shifted in a thickness direction of the optical film-thickness. Therefore, without exerting any influence on fundamental characteristics, such as the wavelength range, an optical film-thickness of at least one of the film layers can be adjusted such that the electric field intensity peak is shifted to appear in the low-refractive-index film layer while avoiding appearing in the high-refractive-index film layer.

In the above multilayer-film mirror having 20 or more film layers, if the film layer in an intermediate position thereof is subjected to the adjustment in optical film-thickness, the wavelength range or the reflectance will be shifted or lowered to cause difficulty in maintaining original characteristics. Thus, it is preferable to adjust respective optical film thicknesses of one or more of the film layers located relatively close to the substrate, and one or more of the film layers located relatively far from the substrate. In particular, the optical film thickness of the distal film layer located at the farthest position from the substrate may be deviated from an integral multiple of ½ of the wavelength λ of the intended light, so that the electric field intensity peak in the multilayer film can be shifted to appear in the low-refractive-index film layer.

In order to provide higher reflectance in the entire multilayer film, it is preferable to increase a difference between respective reflective indexes of the high-refractive-index film layer and the low-refractive-index film layer. For this reason, the dielectric material having a relatively high refractive index may be either one selected from the group consisting of magnesium oxide (MgO), hafnium oxide (HfO₂), titanium oxide (TiO₂), aluminum oxide (Al₂O₃), zirconium oxide (ZrO₂), tantalum pentoxide (Ta₂O₅) and zinc selenide (ZnSe), and the dielectric material having a relatively low refractive index may be either one selected from the group consisting of thorium fluoride (ThF₄), barium fluoride (BaF₂), magnesium fluoride (MgF₂), lithium fluoride (LiF), calcium fluoride (CaF₂), lanthanum fluoride (LaF₃), gadolinium fluoride (GdF₃), neodymium fluoride (NdF₃), dysprosium fluoride (DyF₃), lead fluoride (PbF₂), aluminum fluoride (AlF₃), cryolite (Na₃AlF₆), sodium fluoride (NaF), strontium fluoride (SrF₃) and silicon oxide (SiO₂).

When the wavelength of the intended light is in the range of about 400 to 1200 nm, tantalum pentoxide is particularly suitable as the dielectric material having a relatively high refractive index. When the wavelength of the intended light is in the range of about 200 to 300 nm, hafnium oxide or aluminum oxide is particularly suitable as the dielectric material having a relatively high refractive index.

As above, in the solid-state laser mirror of the present invention, the electric field intensity peak is located in the low-refractive-index film layer, and thereby an energy loss due to absorption can be reduced as compared with a solid-state laser mirror having an electric field intensity peak located in a high low-refractive-index film layer. This makes it possible to improve the reflectance more than ever before so as to get closer to 100%. In addition, thermal damages due to absorption of light energy can be suppressed. This makes it possible to prevent thermal distraction in the film layers so as to achieve enhanced durability even when used in a high-power laser.

### BRIEF DESCRIPTION OF THE DRAWINGS

FIG. 1 is a schematic sectional view of a multilayer-film mirror according to one embodiment of the present invention.

FIGS. 2A and 2B are graphs showing simulation results on a peak shift of electric field intensity in conjunction with adjustment in optical film-thickness of a film layer.

### DETAILED DESCRIPTION OF THE EMBODIMENTS

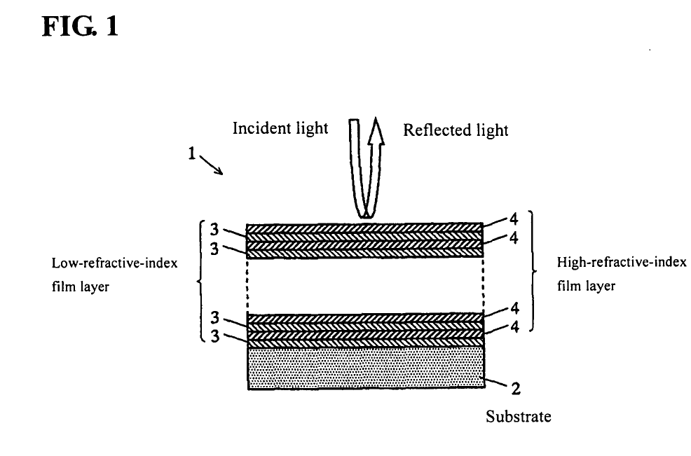

A solid-state laser multilayer-film mirror according to one embodiment of the present invention will now be described. FIG. 1 is a schematic sectional view of the multilayer-film mirror.

The multilayer-film mirror 1 comprises a substrate 2 made of synthetic silica and subjected to precision polishing, i.e., polished to have a surface with high flatness, and a multilayer film formed on the substrate 2 by alternately laminating a low-refractive-index film layer 3 made of a dielectric material having relatively low refractive index, and a high-refractive-index film layer 4 made of a dielectric material having a relatively high refractive index. Each of the film layers 3, 4 may be formed using a conventional apparatus for forming a thin film based on a vapor-phase deposition process, such as a resistance heating vapor deposition process, an ion beam process or a sputtering process.

For example, when the multilayer-film mirror 1 is used in a solid-state laser having a wavelength range of 400 to 1200 nm, the low-refractive-index film layer 3 may be made of silicon oxide (SiO₂) (refractive index around a wavelength of 550 nm: 1.45), and the high-refractive-index film layer 4 may be made of tantalum pentoxide (Ta₂O₅) (refractive index around a wavelength of 550 nm: 2.16). In this case, the large difference in refractive index can facilitate increasing a reflectance of the multilayer-film mirror 1. A total number of the film layers 3, 4 is set at about 25 to 30. Each of the film layers 3, 4 is designed to have a fundamental optical film-thickness which is an integral multiple of ½ of a wavelength λ of an intended light, except that an optical film-thickness of at least one of the film layers 3, 4 is adjusted such that a peak of an electric field intensity in the multilayer-film mirror 1 appears in the low-refractive-index film layer 3 while avoiding appearing in the high-refractive-index film layer 4.

Specifically, in the multilayer-film mirror 1, a reflection occurs at a boundary surface between the adjacent film layers, and, in the course of the repetitive reflections, four electric fields generated by respective P-wave (vertical) and S-wave (horizontal) deflection components of a traveling wave in a positive direction and a reflected wave in a negative direction are superimposed to form an eclectic field intensity distribution where a peak and a bottom alternately appear in a thickness direction. Thus, when an optical film-thickness of at least one of the film layers is deviated from the above fundamental value, the superimposed state of the electric fields is changed, and the peak positions are shifted in the film thickness direction.

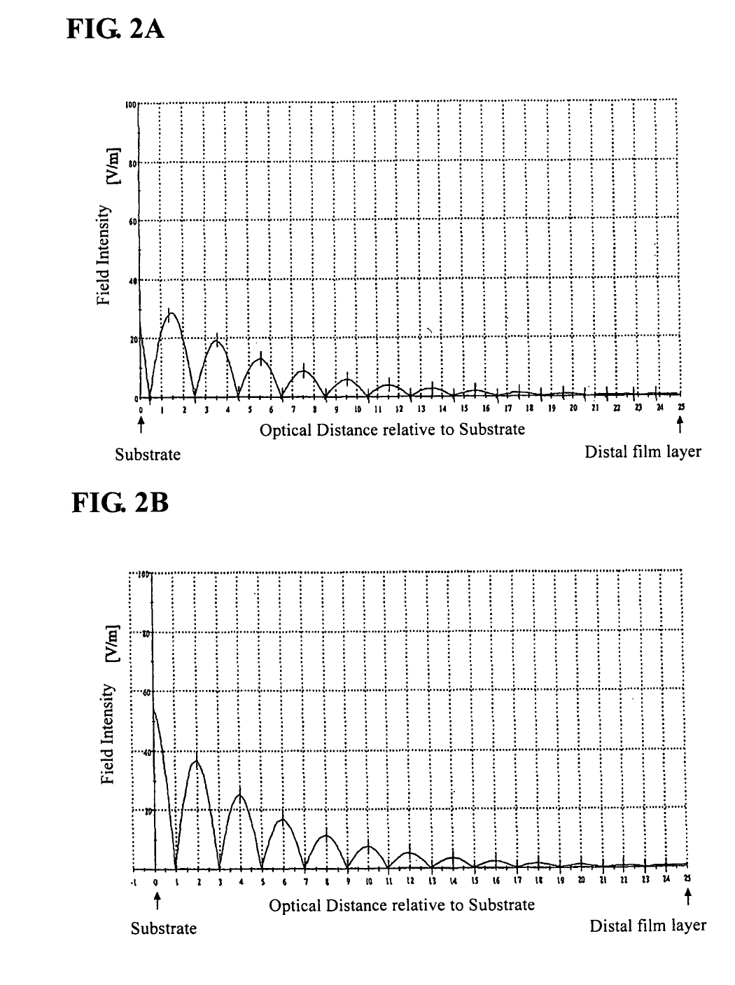

A peak shift of electric field intensity in conjunction with the adjustment in optical film-thickness of the film layer will be described below with reference to FIGS. 2A and 2B which show simulation results thereon. In this simulation, a total number of the film layer was set at 25. In FIGS. 2A and 2B, the horizontal axis represents an optical distance relative to the surface of the substrate 2, and the numerical values on the horizontal axis are defined on the assumption that the proximal film layer (1st layer) in contact with the substrate 2 is “1”, and the distal film layer (25th layer) farthest from the substrate 2 is “25”.

FIG. 2B shows a simulation result on the condition that all of the film layers have the same optical film-thickness, and FIG. 2B shows a simulation result on the condition that optical film-thicknesses of one or more of the film layers is adjusted. Specifically, given that a fundamental optical film-thickness is “1”, the respective optical film-thicknesses of the 2nd and 3rd film layers located relatively close to the substrate 2, and the 22nd to 25th film layers were adjusted. As shown in FIG. 2B, in the conventional multilayer-film mirror, the electric filed intensity peak is located at the positions “2”, “4”, —, i.e., in the 2nd film layer, the 4th film layer—, which are the high-refractive-index film layers 4. Thus, the loss of light energy is increased, and the film layers are likely to be damaged when used in a high-power laser.

In contrast, as shown in FIG. 2A, in the multilayer-film mirror 1 according to this embodiment, the electric filed intensity peak is shifted from the positions “2”, “4”, —, and substantially located in the low-refractive-index film layers 3. This makes it possible to reduce the light energy loss and suppress damages of the film layers even when used in a high-power laser. As the result of calculation of a reflectance of the multilayer-film mirror 1 according to this embodiment, it was verified that a reflectance of 99.9% or more can be achieved in a wavelength of 946 nm.

When the multilayer-film mirror 1 is used in a solid-state laser in deep-ultraviolet range of 200 to 300 nm, the high-refractive-index film layer has to be made of a material having no light adsorbability in this wavelength range. Thus, the low-refractive-index film layer 3 may be made of silicon oxide (SiO₂), and the high-refractive-index film layer 4 may be made of hafnium oxide (HfO₂) (refractive index around a wavelength of 550 nm: 1.95). In this case, the large difference in refractive index can facilitate increasing a reflectance of the multilayer-film mirror 1. In addition, the hafnium oxide has almost no light adsorbability in the ultraviolet range. Thus, even if the third harmonic or the fourth harmonic in a high-power laser has high light intensity, the hafnium oxide-based high-refractive-index film layer 4 having no light adsorbability can reduce the light energy loss and avoid damages.

Although the present invention has been described based on one specific embodiment thereof, it is to be understood that various changes and modifications will be apparent to those skilled in the art. Therefore, unless otherwise such changes and modifications depart from the scope of the present invention hereinafter defined, they should be construed as being included therein.

What is claimed is:

1. A mirror for a solid-state laser, comprising a multilayer film formed on a substrate by alternately laminating a high-refractive-index film layer made of a dielectric material having a relatively high refractive index, and a low-refractive-index film layer made of a dielectric material having a relatively low refractive index, wherein at least one of said film layers has an optical film-thickness adjusted such that a peak of an electric field intensity in the multilayer film with respect to a wavelength of intended light appears in said low-refractive-index film layer.

2. The mirror as defined in claim 1, wherein:
a total number of the film layers in said multilayer film is 20 or more; and
each of said film layers has a fundamental optical film-thickness which is an integral multiple of ½ of the wavelength λ of said intended light, except that respective optical film thicknesses of one or more of said film layers located relatively close to said substrate, and one or more of said film layers located relatively far from said substrate, are adjusted to allow said electric field intensity peak in the multilayer film to appear in said low-refractive-index film layer.

3. The mirror as defined in claim 1, wherein:
said dielectric material having a relatively high refractive index is either one selected from the group consisting of magnesium oxide, hafnium oxide, titanium oxide, aluminum oxide, zirconium oxide, tantalum pentoxide and zinc selenide; and
said dielectric material having a relatively low refractive index is either one selected from the group consisting of thorium fluoride, barium fluoride, magnesium fluoride, lithium fluoride, calcium fluoride, lanthanum fluoride, gadolinium fluoride, neodymium fluoride, dysprosium fluoride, lead fluoride, aluminum fluoride, cryolite, sodium fluoride, strontium fluoride and silicon oxide.

4. The mirror as defined in claim 2, wherein:
said dielectric material having a relatively high refractive index is either one selected from the group consisting of magnesium oxide, hafnium oxide, titanium oxide, aluminum oxide, zirconium oxide, tantalum pentoxide and zinc selenide; and
said dielectric material having a relatively low refractive index is either one selected from the group consisting of thorium fluoride, barium fluoride, magnesium fluoride, lithium fluoride, calcium fluoride, lanthanum fluoride, gadolinium fluoride, neodymium fluoride, dysprosium fluoride, lead fluoride, aluminum fluoride, cryolite, sodium fluoride, strontium fluoride and silicon oxide.
